(19) United States
(12) Patent Application Publication
(10) Pub. No.: US 2023/0204380 A1
(43) Pub. Date: Jun. 29, 2023

(54) METHOD FOR LOCATING CARRIAGEWAY MARKINGS IN A MOTOR VEHICLE AND MOTOR VEHICLE

(71) Applicant: AUDI AG, Ingolstadt (DE)

(72) Inventor: Rachid KHLIFI, Garching (DE)

(73) Assignee: AUDI AG, Ingolstadt (DE)

(21) Appl. No.: 17/996,426

(22) PCT Filed: Jan. 22, 2021
(86) PCT No.: PCT/EP2021/051420

§ 371 Date: Oct. 17, 2022

(30) Foreign Application Priority Data
May 14, 2020 (DE) 10 2020 113 149.6

(51) Int. Cl. G01C 21/00; B60W 60/00; G01S 13/88; G01S 13/86; G01S 13/89; G06V 20/56

(52) U.S. Cl. CPC G01C 21/3841; G01C 21/3815; B60W 60/001; G01S 13/885; G01S 13/867; G01S 13/89; G06V 20/588; B60W 2420/52; B60W 2552/10; B60W 2554/4041; B60W 2552/53; B60W 2420/42

(57) ABSTRACT

The approach relates to a method for locating roadway markings by a motor vehicle, wherein the motor vehicle has a camera, the image data from which are evaluated into roadway marking data describing the presence and the position of roadway markings. At least one ground penetrating radar sensor of the motor vehicle is directed at the ground being driven over, the radar data from which sensor is evaluated to determine ground data describing the ground structure of the ground being driven over. A mapping database is used in which roadway marking data indicating the presence of roadway markings and ground data assigned to the same recording location are stored in association with one another. At least on detection of a ground covering obscuring roadway markings in the camera data using the ground data, a current ground structure is compared on the basis of the ground data with at least one or more ground structures in the database and, in the event of a match, the roadway marking data associated with the ground data of the matching ground structure are used.

### TECHNICAL FIELD

The present disclosure relates to a method for locating roadway markings in a motor vehicle, wherein the motor vehicle has a camera, the image data from which are evaluated into roadway marking data describing the presence and the position of roadway markings. The present disclosure also relates to a motor vehicle.

### BACKGROUND

A large number of proposed and already implemented vehicle systems in modern motor vehicles can use knowledge of the relative position of roadway markings to the motor vehicle. Examples of such vehicle systems include driver assistance systems, which relate in particular to the lateral driving of the motor vehicle, as well as vehicle systems designed for at least partially automatic driving of the motor vehicle, in the case of which automatic driving interventions, knowledge of the further course of the currently travelled or upcoming lane can be important. For example, lane-keeping assistance systems and lane departure warning systems are known in the prior art, which can issue warnings when the motor vehicle is about to move out of its lane and/or can carry out self-correcting driving interventions. Knowledge of the different lane positions is also important for driver assistance systems that support a lane change. A large number of other vehicle systems can also expediently use data relating to roadway markings, for example with regard to the road currently travelled, the number of lanes, the lane in which the motor vehicle is travelling, the lane width and the like.

To detect such roadway markings inside a motor vehicle, it is known to use cameras directed at the area in front of the motor vehicle, the image data from which are evaluated for the presence and the position of roadway markings, wherein the evaluation result can be given, for example, by roadway marking data. This roadway marking data can then be used by the relevant vehicle systems for their respective functions. Problems always arise with detections of this type when the roadway markings are difficult or impossible to recognize optically. For example, roadway markings may be covered by snow, mud, dirt, and the like. It is also conceivable that roadway markings are worn away and/or destroyed over time. An optical sensor system can then no longer supply roadway marking data. While this is less critical in vehicle systems in which the driver is still “in the loop”, i.e., observing what is happening on the road himself, since the driver can assess the situation himself and react accordingly, this is no longer the case with highly automated driving functions, so that failure to recognize the roadway markings can be very critical and, in particular, can lead to the corresponding vehicle guidance function being discarded.

DE 10 2016 224 558 A1 relates to a method for determining the position of a vehicle. The vehicle has a navigation system and a ground penetrating radar system, in which the ground in the area surrounding the vehicle is scanned with the ground penetrating radar. Ground penetrating radar system position data are determined from a comparison with ground reference data, and the current vehicle position is determined with both navigation system position data and ground penetrating radar system position data. This should allow the position to be determined more precisely.

DE 10 2018 132 366 A1 relates to wireless vehicle charging. A receiving coil on a vehicle is to be aligned with a charging coil using ground penetrating radar data. Thus, the system does not require visual identification of above-ground objects and/or roadway markings in order to align a receiving coil of the receiver with a charging coil of the transmitter. In particular, the system is useful in many outdoor environmental conditions, particularly in scenarios where the above-ground objects and/or roadway markings are absent, the roadway markings are worn or weathered, and/or the markings are obscured by leaves, snow, dirt or other debris.

DE 10 2018 202 267 A1 relates to a method for illuminating a roadway while supplementing a roadway marking. In order to allow increased information content for the driver of a motor vehicle when illuminating the roadway, the course of at least one roadway marking in the area surrounding the motor vehicle is at least partially determined and the light distribution is calculated in such a way that the course of the roadway marking is supplemented at least in regions by the emission of the brightness distribution onto the roadway. The course of the roadway marking can be recorded using map data and/or by a camera of the motor vehicle. Missing markings are determined by interpolation, extrapolation and/or smoothing of the detected roadway marking. In areas where roadway markings are absent or obscured, obscured areas can be extrapolated or interpolated. Furthermore, the roadway marking can be compared with the roadway marking determined using the digital map in order to supplement areas that are missing by means of the comparison.

### BRIEF DESCRIPTION OF DRAWINGS/FIGURES

FIG. 1 is a schematic diagram of a motor vehicle according to the invention on the ground being driven over,

FIG. 2 is a schematic diagram of the mode of operation of the method according to the invention, and

FIG. 3 is a schematic diagram of a motor vehicle according to the invention.

### DETAILED DESCRIPTION

The present disclosure is based on the object of specifying a possibility for locating roadway markings that is as robust and accurate as possible, even in the case of a roadway marking that is obscured and/or otherwise unrecognizable optically.

In order to achieve this object, a method of the type mentioned at the outset provides, according to the present disclosure, that in addition, at least one ground penetrating radar sensor of the motor vehicle is used and is directed at the ground being driven over, the radar data from which sensor is evaluated to determine ground data describing the ground structure of the ground being driven over, wherein a mapping database is used in which roadway marking data indicating the presence of roadway markings and ground data assigned to the same recording location are stored in association with one another. On detection of a ground covering obscuring roadway markings, in particular in the camera data, a current ground structure is compared on the basis of the ground data with at least some of the ground structures in the database and, in the event of a match, the roadway marking data associated with the ground data of the matching ground structure are used.

A ground covering obscuring roadway markings can, for example, comprise snow, mud, leaves and/or other dirt. This can be recognizable, for example, in the image data of the camera, whereby other environmental sensors of the motor vehicle, for example radar sensors and the like, can also be used, in particular additionally, in order to be able to determine the optical non-detectability of roadway markings if this is required in a specific embodiment of the present disclosure. A comparison with digital map data is also expedient here, after which it can be determined, for example, whether roadway markings should be present.

While the method according to the present disclosure is particularly favorable for obscured roadway markings, it is also expedient to carry out the corresponding comparison of the ground structures, since then an increase in the robustness of the determination of the roadway markings is made possible and/or a plausibility check can be implemented. In particular, the comparison can always be carried out when the information relating to the current recording location is already available within the mapping database.

After the relative installation location of the camera and the ground penetrating radar sensor is fixed and possibly even known, there is a clear assignment of the ground structures to the roadway markings, including with regard to their position. In particular, it can be provided within the scope of the present disclosure that if there is a lateral displacement of the matching ground structures relative to one another, this displacement is used to correct the position of the roadway markings in the associated roadway marking data. Therefore, it can be determined whether the motor vehicle is passing over a ground structure that is slightly laterally offset, so that the positions of the roadway marking data that are usually stored relative to the motor vehicle in the roadway marking data can also be adjusted accordingly, and the relative position of the roadway markings to the motor vehicle is therefore correctly known.

A ground penetrating radar (GPR) sensor is a radar sensor, the radar signals of which penetrate the ground and can characterize existing reflection patterns at different depths. For example, the radar data can be sorted and evaluated layer by layer according to reflections from different ground layers.

According to the present disclosure, it is now specifically proposed to create a mapping database that allows ground structures to be assigned to certain roadway markings present at a corresponding location, so that the ground structures can be used to determine the presence and the position of roadway markings, and therefore a suitable roadway marking data set, even if the roadway markings cannot be detected optically, for example because they are obscured. Concretely, it can be provided that in order to generate the database using the motor vehicle and/or at least one structurally identical motor vehicle, ground data and roadway marking data are determined during at least one trip, and roadway marking data and ground data which are assigned to the same recording location and indicate the presence of roadway markings are stored in association with one another in the mapping database. This means that whenever the motor vehicle or a motor vehicle that is structurally identical in terms of the relative arrangement and orientation of the ground penetrating radar sensors and camera travels a route along which both ground data and, based on the detectability of roadway markings, roadway marking data can be recorded, the roadway marking data are stored in the mapping database in association with the corresponding ground data, which incidentally can also be recorded over a period of time, so that when the corresponding ground structures described by the ground data are detected again, roadway marking data can be obtained even if the roadway markings cannot be detected optically. Therefore, by merging the ground structure detected by the ground penetrating radar sensor and the optically determined roadway marking data, a mapping database is generated that allows a comparison with currently measured ground structures, from which the correct, assigned roadway marking data can be derived. The comparison of the ground structures thus substantially corresponds to a localization of the motor vehicle in a ground map of the mapping database, which also contains where roadway markings are present.

When driving on the ground, in particular on a roadway, the ground penetrating radar sensor therefore senses the ground structure and compares the current ground structure, which can be understood as a map section, with the ground structures stored in the mapping database, which can be understood as an overall map. By comparing the ground structure currently sensed with the ground penetrating radar and the ground structure stored in the system, roadway markings that are obscured by snow, for example, can still be detected.

This is based on the finding that the ground structure does not change or hardly changes over the years or due to weather influences, so that a robustly detectable reference is available, which provides roadway markings that cannot be detected optically. Consequently, roadway markings are indirectly detected by comparison with the mapping database.

In this way, the method according to the present disclosure allows safe driving when roadway markings are obscured by snow, dirt, aging and the like. The ground structure represents a reliable map for matching. For automated driving, this solution also allows more reliable driving in the case of obscured roadway markings. While optical sensors cannot detect roadway marking data when roadway markings are obscured, ground penetrating radar technology allows penetration of the obscuring layer, such as snow or dirt, and allows the roadway marking data to be determined despite this obscuring. Consequently, functions related to roadway markings, in particular driver assistance functions, can be carried out despite the roadway markings being obscured. For example, despite roadway markings that are not optically recognizable, roadway markings can be visualized for the driver, a driver can be warned when moving out of the lane he is currently driving in, automatic lane changes can be carried out despite the roadway markings being obscured, detected objects can be correctly assigned to lanes, in order to recognize critical scenarios in good time and avoid collisions, various trajectories can be calculated correctly without direct optical sensing of the roadway markings, the motor vehicle or other detected road users can be localized in the lane despite the roadway markings being obscured, the motor vehicle can be automatically steered into a lane and the like.

In an advantageous development of the present disclosure, the ground penetrating radar sensor can have a penetration depth of at least 0.5 m. For example, it is conceivable to consider at least 20, for example 25, different depth layers in the evaluation. In this way, a sufficient amount of information describing the ground structures is generated. Furthermore, the ground penetrating radar sensor can be operated with a carrier frequency between 1 MHz and 1 GHz and/or with a frequency bandwidth of at least 250 MHz, in particular at least 500 MHz. In order to create a specific depth of penetration in the ground, a specific frequency range must be used. Ground penetrating radar sensors in the range of 1 MHz to 1 GHz carrier frequency offer the possibility of penetrating the ground. For this purpose, a specific frequency bandwidth is preferably used, which allows a desired distance resolution. If the penetration depth is low, a higher frequency bandwidth, for example 500 MHz, can be used in order to analyze the layers (at small distances, for example approximately 20 cm) of the ground in a distance-resolving manner. In a specific embodiment of the present disclosure, it can be provided, for example, that with a distance resolution in the range of less than 2 cm, the ground is scanned in layers at a distance of 2 cm up to a penetration depth of 0.5 m, i.e., 25 layers below the roadway are scanned, allowing high-resolution mapping of the ground.

The ground penetrating radar sensor for recording the radar data can be operated as a pulse radar or continuous wave radar. In general, it can be said that the ground penetrating radar sensor should act monostatically, meaning that it sends and receives the radar signals with a common antenna arrangement. Currently known ground penetrating radar sensors, which are therefore easily available, are traditionally based on pulse technology, wherein at least one transmitting antenna element of the antenna arrangement of the ground penetrating radar sensor emits a series of radar pulses, with at least one receiving antenna element of the antenna arrangement of the ground penetrating radar sensor detecting the reflected radar pulses from the ground. The time between sending and receiving allows the distance measurement or localization of the individual reflections. Pulse radar technology is used particularly frequently because the Doppler measurement (speed of movement of detected objects) plays no role in the analysis of the ground.

In contrast, the use of continuous wave radar technology (FMCW-frequency modulated continuous wave) offers the possibility of carrying out a frequency spectral analysis in order to generate additional information from the frequency spectrum. Therefore, an expedient development of the present disclosure can provide for a frequency spectrum analysis to be carried out when operating as a continuous wave radar, in particular for the detection and elimination of ambiguities. This makes it easier to distinguish between different goals.

Provision can be made with particular advantage for the ground penetrating radar sensor to be operated as a radar with a synthetic aperture, in particular when the ground penetrating radar sensor is oriented perpendicularly to the direction of travel. Consequently, the usually given orthogonality (90°) between the direction of movement of the motor vehicle and the direction of emission of the ground penetrating radar sensor (forwards or downwards) can allow the use of the high-resolution SAR radar concept (synthetic aperture radar) to massively increase the angular resolution performance in the analysis of the ground. The principle of the synthetic aperture is to replace the snapshot of a large antenna array with many images of a small, moving antenna array. In the course of this movement, each reflection object in the target area is illuminated from a changing angle and recorded accordingly. If the path of the antenna arrangement is known with sufficient accuracy and the landscape, which is the case with the ground, is immobile, the aperture of a larger antenna arrangement can be synthesized from the intensity and phase position of the received radar signals and thus a high spatial resolution in the direction of movement of the antenna arrangement can be achieved.

In a further, particularly preferred embodiment of the present disclosure, it is provided that in the mapping database, absolute, in particular geodetic, position information and/or position information relating to a digital map is also assigned to the ground data and roadway marking data associated with one another. This makes it possible to initially at least roughly localize the host vehicle within the mapping database in order to be able to carry out a robust matching of the ground structures that can be carried out in real time. Therefore, it can be provided that on the basis of current position information of the motor vehicle, determined in particular with a position sensor, for example a GPS sensor, of the motor vehicle, the amount of data to be used for the comparison from the database is restricted to an area around the position described by the current position information of the motor vehicle. The position sensor can in particular be a sensor of a global navigation satellite system, in particular a GPS sensor. In this way, possible ground structures are preselected, so to speak, in order to massively reduce the number of comparisons to be carried out and thus to obtain reliable results more quickly. The size of the area can be fixed, but it is also conceivable to adapt the area size as a function of an error value assigned to the position information, for example to select larger areas if the position information is more uncertain than if the position information is known with extreme accuracy.

In this context, it can also be expedient for the mapping database, which may represent a large amount of data, to be stored outside the vehicle and only the currently required mapping data (at least ground structure data and associated roadway marking data) to be downloaded into the vehicle. Therefore, it can be provided that the mapping data describing the area and/or a region encompassing the area can be retrieved as a local database for the comparison from a mapping database stored outside the motor vehicle. This can be done in particular via a cellular network and/or the Internet.

In this context, it should also be noted that it may be useful in principle to use a mapping database that is managed centrally, for example on a backend device, since then various motor vehicles that are structurally identical, at least with regard to the ground penetrating radar sensor and the camera, can all contribute to the development of the mapping database, which thus obtains a high degree of coverage and high accuracy. In particular, information can also be obtained for the host vehicle if the host vehicle has not yet passed a route section itself If the ground structure is abstracted, which is preferably carried out, slightly different data can also be combined without any problems due to deviations in measurement conditions and the like.

In general, it is also particularly advantageous within the scope of the present disclosure if, in order to determine the ground data, the ground structure described by the radar data is abstracted, in particular to reduce the amount of data, in particular a ground map is determined. For example, it can be specifically provided that only reflection objects that meet a relevance criterion are included in the ground data, wherein the relevance criterion requires in particular a minimum size and/or a minimum reflectivity, and/or in particular reflection objects that have been included are assigned an object class by classification, in particular a crack class and/or at least one inclusion object class. In particular, the course of cracks in the ground, the position of air pockets in the ground and/or the position of other included objects in the ground represent an excellent basis for a ground map in which ground structures, described in particular by local ground maps derived from currently recorded radar data, can be easily found by comparison, in particular when restricted to an area around a current position of the motor vehicle. In order to further expediently reduce the amount of data, a minimum size and/or a minimum reflectivity for reflection objects, in particular cracks and/or inclusions, may also be required.

Irrespective of whether they were determined by means of the camera or from the mapping database, the roadway marking data can be used as is fundamentally known in the prior art. It is conceivable, for example, for the current roadway marking data to be evaluated to determine a lane width and/or a roadway width and/or a number of lanes and/or a lane assignment for the host vehicle and/or for at least one other road user. Furthermore, the roadway marking data can be evaluated by and/or for at least one vehicle system, in particular a driver assistance system and/or a vehicle system designed for at least partially automatic driving. Corresponding examples have already been presented in more detail with regard to the advantages of the present disclosure.

In addition to the method, the present disclosure also relates to a motor vehicle having a camera, at least one ground penetrating radar sensor and a control device designed to carry out the method according to the present disclosure. All statements relating to the method according to the present disclosure can be analogously transferred to the motor vehicle according to the present disclosure, with which the already mentioned advantages can thus also be obtained. In particular, the control device can be a control unit, in particular a control unit assigned to at least one vehicle system, for example a driver assistance system. The control unit can in particular be what is known as a control unit of a central driver assistance system, in which the functions of a plurality of driver assistance systems are combined. The control device can have at least one processor, which implements functional units suitable for executing the method according to the present disclosure, and/or a storage device, in particular for the mapping database and/or the local database. Furthermore, within the scope of the present disclosure, the term “camera” is to be understood broadly as an imaging optical sensor, so that in particular imaging lidar sensors can also be used as a camera.

FIG. 1 is a schematic diagram of a motor vehicle 1 according to the present disclosure, which drives on the ground 2, in this case on a roadway 3. The motor vehicle is located within a lane marked by roadway markings 4. In order to detect roadway markings 4, the motor vehicle 1 has a camera 5 directed at the area in front of the motor vehicle as an imaging optical sensor device, which camera can be installed behind a windshield 6 of motor vehicle 1, for example.

In the present case, at least one of the roadway markings 4 is covered by a layer 7, for example a layer of snow, dirt or leaves, so that it cannot be detected in the image data of the camera 5.

For such a case, the motor vehicle 1 now also has two ground penetrating radar sensors 8 in the present case, the detection ranges 9 of which are directed vertically downwards. Each of the ground penetrating radar sensors 8 is operated with a carrier frequency in the range from 1 MHz to 1 GHz at a frequency bandwidth of 500 MHz such that a penetration depth of 0.5 m is given. Due to the high frequency bandwidth, there is also a high distance resolution, in particular of less than 2 cm. After the ground penetrating radar sensors 8 are aligned downwards and thus perpendicular to the direction of movement of the motor vehicle 1, usually forwards, but in any case horizontally, the principle of the synthetic aperture is also used to increase the angular resolution, which means that successively recorded radar signals from a reflection object can be viewed together to generate an enlarged virtual aperture.

In the present case, with a penetration depth of 0.5 m, a division into 50 layers of 2 cm can be made, in which the ground 2 can be mapped, indicated by the dashed mapping areas 10. By abstracting reflection objects and classifying reflection objects that have a relevance criterion, in particular a minimum size and/or a minimum reflectivity, the radar data from the ground penetrating radar sensors 8 can be evaluated into ground data describing the ground structure of the ground 2. This ultimately results in a currently recorded, local ground map.

The ground penetrating radar sensors 8 can be operated as a pulse radar or as a continuous wave radar. The use of pulse radars is common for ground penetrating radar sensors 8 and takes advantage of the fact that no velocity Doppler information is required. However, the use of continuous wave radar technology allows frequency spectrum analysis, which can resolve ambiguities and provide additional information if necessary.

The ground structure data can now be used in the motor vehicle 1 to determine the presence and the relative position of roadway markings 4, either for plausibility checks and/or to increase the robustness of roadway markings 4 that are optically recognizable anyway, or to determine the presence and the position of roadway markings 4 even if they are not optically recognizable, for example due to the layer 7.

For this purpose, access is made to a mapping database stored inside or outside the motor vehicle 1, which database contains ground structure data and roadway marking data associated with one another, each with respectively assigned position information, in this case geodetic positions. Therefore, the mapping database substantially contains a ground map covering a large area as an overall map. If a relevant local area is now selected from the mapping database on the basis of position information of the motor vehicle 1 determined by means of a position sensor 11 of the motor vehicle 1, which is possible on the basis of the position information there, the currently measured ground structure, in particular the local ground map mentioned as a map section, can be compared with the ground structures of the area, i.e., the larger ground map, so that the motor vehicle 1 can be localized within the larger ground map and the correct roadway marking data results as those associated with the matching ground structure. Naturally, lateral displacements can also be taken into account here.

The mapping database may have been determined by the motor vehicle 1 or by motor vehicles that are structurally identical with regard to the camera 5 and the ground penetrating radar sensors 8, when the roadway 3 was previously driven on, the roadway markings 4 having been optically detectable at this point in time. In particular, a fleet of motor vehicles can be used to generate the mapping database, which can then be compiled on an external backend device, with mapping data from at least one region encompassing the area being able to be transmitted to the motor vehicle 1 as a local database. Due to the abstraction of the ground structures and the restriction to an area surrounding the current position of the motor vehicle, a small amount of data is given.

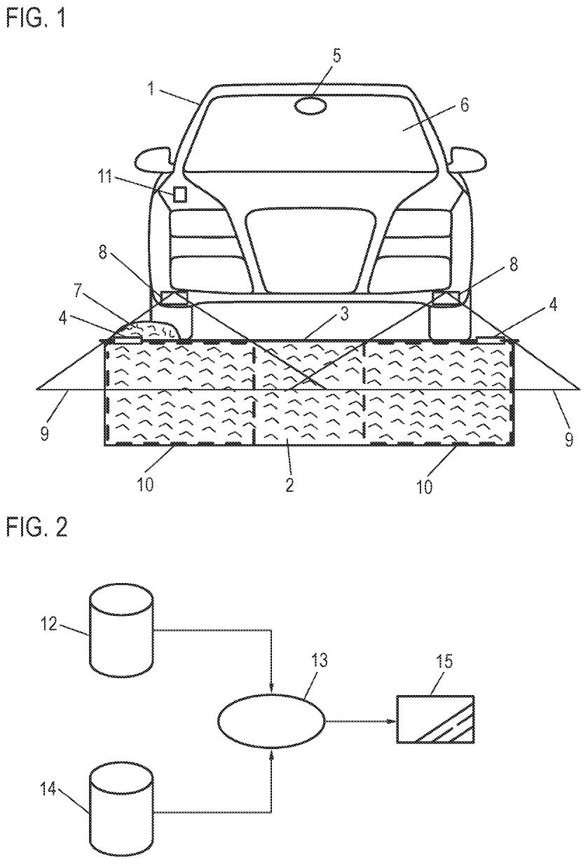

FIG. 2 explains the concept on which the present disclosure is based by means of a simple diagram. The mapping database 12 is provided so that in one step 13, a matching ground structure can be found from the mapping database 12 by comparing current ground data 14, in particular the local ground map. The correct, assigned current roadway marking data 15 then follow from this.

The roadway marking data 15 can, as is fundamentally known, be evaluated further, for example in order to be able to determine lane width, roadway width, number of lanes and/or at least one lane assignment. Corresponding information can be evaluated, for example, by corresponding vehicle systems, in particular driver assistance systems and/or vehicle systems designed for at least partially automatic driving of the motor vehicle 1.

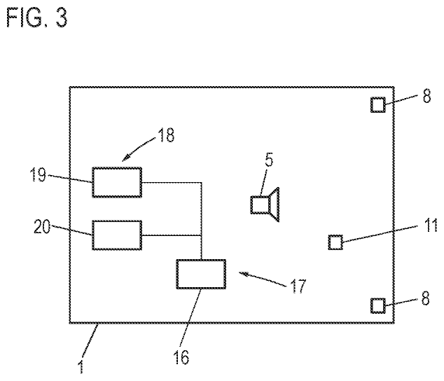

In this regard, FIG. 3 is a functional schematic diagram of the motor vehicle 1 according to the present disclosure. In addition to the camera 5, the ground penetrating radar sensors 8 and the position sensor 11, the motor vehicle 1 has a control device 17 designed as a control unit 16, which is designed to carry out the method according to the present disclosure, i.e., in particular to compare currently determined ground data 14 with ground structures in the mapping database 12, in order to be able in particular to determine corresponding roadway marking data 15 even in the case of roadway markings 4 that cannot be detected optically by the camera 5. The roadway marking data can then be made available to other vehicle systems 18, in particular to at least one driver assistance system 19 and/or at least one vehicle system 20 designed for fully automatic driving of the motor vehicle 1.

1.-13. (canceled)

14. A method for locating roadway markings by a motor vehicle, the method comprising:
directing a ground penetrating radar sensor of the motor vehicle at ground being driven over;
determining ground data describing a ground structure of the ground being driven over by evaluating radar data from the ground penetrating radar sensor;
storing, in a mapping database, roadway marking data indicating a presence of roadway markings and associated ground data assigned to a recording location;
based on detection, in image data from a camera, of a ground covering obscuring roadway markings, comparing a current ground structure with one or more ground structures in the mapping database; and
in the event of a match found in the comparing, using the roadway marking data associated with the ground data of the matching ground structure.

15. The method of claim 14, wherein the ground penetrating radar sensor has at least one of a penetration depth of at least 0.5 m, a carrier frequency between about 1 MHz and about 1 GHz, or a frequency bandwidth of at least 250 MHz.

16. The method of claim 14, wherein the ground penetrating radar sensor uses a pulse radar or a continuous wave radar.

17. The method of claim 14, wherein the directing the ground penetrating radar sensor further comprises:
orienting the ground penetrating radar sensor perpendicularly to a direction of travel, wherein the ground penetrating radar sensor uses a synthetic aperture.

18. The method of claim 14, further comprising:
assigning, in the mapping database, to the ground data and the roadway marking data associated with the ground data, at least one of absolute position information or position information relating to a digital map.

19. The method of claim 18, wherein the comparing the current ground structure with one or more ground structures in the mapping database further comprises:
restricting, for use in the comparing, an amount of data to an area around a current position information of the motor vehicle.

20. The method of claim 19, wherein the comparing the current ground structure with one or more ground structures in the mapping database further comprises:
retrieving, from the mapping database, data to form a local database for use in the comparing, wherein the mapping database is located outside the motor vehicle, and wherein the data describing the area and/or a region encompassing the position of the motor vehicle.

21. The method of claim 14, wherein the evaluating the radar data includes abstracting the ground structure described by the radar data to thereby reduce the amount of data.

22. The method of claim 21, wherein the determining the ground data incudes using reflection objects that meet a relevance criterion, wherein the relevance criterion requires at least one of a minimum size or a minimum reflectivity, or
the method further comprises:
assigning the reflection objects that have been included, an object class by classification, the object class being at least one of a crack class or an inclusion object class.

23. The method of claim 14, further comprising:
evaluating the current roadway marking data to determine at least one of a lane width, a roadway width, a number of lanes, or a lane assignment for the host vehicle and/or at least one other road user.

24. The method of claim 14, further comprising:
evaluating the roadway marking data for a vehicle system, the being at least one of a driver assistance system or a vehicle system designed for at least partially automatic driving.

25. The method of claim 14, further comprising:
determining, during at least one trip, using the motor vehicle and/or at least one structurally identical motor vehicle, ground data and roadway marking data to thereby generate the mapping database; and
storing in association with one another in the mapping database, roadway marking data and ground data that are assigned to a same recording location, and indicate the presence of roadway markings.

26. A motor vehicle comprising:
a camera;
a ground penetrating radar sensor; and
a control device configured to carry out a method for locating roadway markings, the method comprising:
directing a ground penetrating radar sensor of the motor vehicle at ground being driven over;
determining ground data describing a ground structure of the ground being driven over by evaluating radar data from the ground penetrating radar sensor;
storing, in a mapping database, roadway marking data indicating a presence of roadway markings and associated ground data assigned to a recording location;
based on detection, in image data from a camera, of a ground covering obscuring roadway markings, comparing a current ground structure with one or more ground structures in the mapping database; and
in the event of a match found in the comparing, using the roadway marking data associated with the ground data of the matching ground structure.
